(19) United States
(12) Patent Application Publication
(10) Pub. No.: US 2012/0133164 A1
(43) Pub. Date: May 31, 2012

(54) ADJUSTMENT FLANGE FOR LIFT GUIDES

(75) Inventor: Jesus SANZ GAMBOA, VERA DE BIDASOA (NAVARRA) (ES)

(73) Assignee: S.A. DE VERA (SAVERA), VERA DE BIDASOA (NAVARRA) (ES)

(21) Appl. No.: 13/303,860

(22) Filed: Nov. 23, 2011

(30) Foreign Application Priority Data
Nov. 29, 2010 (ES) P201031749

(51) Int. Cl. B66C 1/44

(52) U.S. Cl. 294/119.1

(57) ABSTRACT

An adjustment flange for lift guides; structured in two identical semi-parts fastened on a support (5) clamping the lift guide between them (G), each of which consists of:
a) a rotary element (1) provided with an axial orifice (11) and a perimeter channel (12) of asymmetric section;
b) an anchor bolt (2) that passes through said axial orifice (11) and an orifice/housing (S1) of the support (S) positioned facing it; and
c) a nut (3), threaded in the body (20) of said bolt (2) with interposition of a washer (4);
   The lift guide (G) is fitted between the two rotary elements (1) positioned facing each other and with their wings ((S1) housed in their perimeter channels (12).

### DESCRIPTION

In the current state of the art various types of flanges are known for fastening lift guides; some exert pressure on the guides (for example, by elastic deformation of some element) and others are fastened to the wing of the guide and do not exert pressure but prevent them from moving horizontally.

Normally, conventional flanges that offer high resistance also generate high friction and the flanges that offer lower friction are not very resistant. Flanges that can combine low friction and high resistance are usually quite complicated to manufacture and assemble.

The object of the invention is included within this industrial sector. It refers to a flange for adjustment of lift guides that does not exert initial pressure, and because of this the friction force can be reduced drastically. Moreover, this adjustment flange, according to the invention, can present quite high resistance values while also being simple to manufacture and assemble.

It is characterized in that, structured in both identical semi-parts fixed on a support clamping the lift guide between them, each of said semi-parts consists basically of a rotating element, with an axial orifice and a perimeter channel of asymmetric section, an anchor bolt, which goes through said axial orifice and an orifice/housing of the support positioned facing each other; and a nut, threaded in the body of said bolt with interposition of washer; the lift guide being fitted between the two rotary elements positioned facing each other, with the wings of the guide housed in the perimeter channels of the rotary elements.

Based on this basic concept, any embodiments that do not essentially change or modify the proposal are included in the object of the invention. Especially included in the object of the invention is that the rotary element remains static or can turn, for which both the rotary elements and the anchor bolts have shapes that are peculiar and characteristic while there is a bushing with an axial orifice and a perimeter seat, so that said anchor bolt, by the action of the nut, axially fastens the bushing, compressing it between the support and its own head, while positioning the rotary element without axial movement so that it can turn freely in the seat of the bushing.

The adjustment flange that is the object of the invention supposes a substantial improvement with respect to the conventional ones, as it solves the serious problem of achieving, in a single flange, the high resistances and low frictions required by today's modern lifts.

For this reason, the content of this application constitutes a new invention that involves inventive activity, and can be applied industrially.

To better understand the object of this invention, a preferential form of practical embodiment is represented in the drawings, subject to accessory changes that do not essentially alter it.

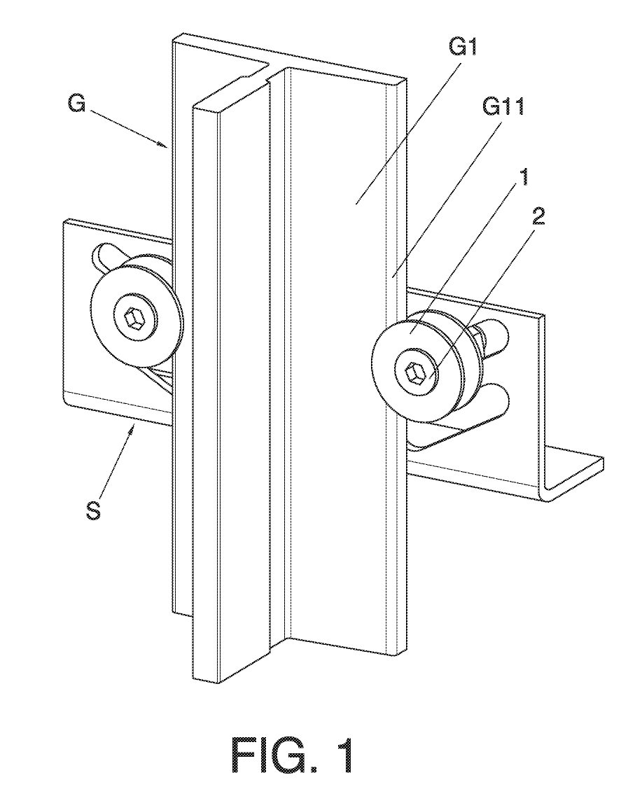

FIG. 1 represents a general schematic view in perspective of an adjustment flange, according to the invention, with its basic components in working position.

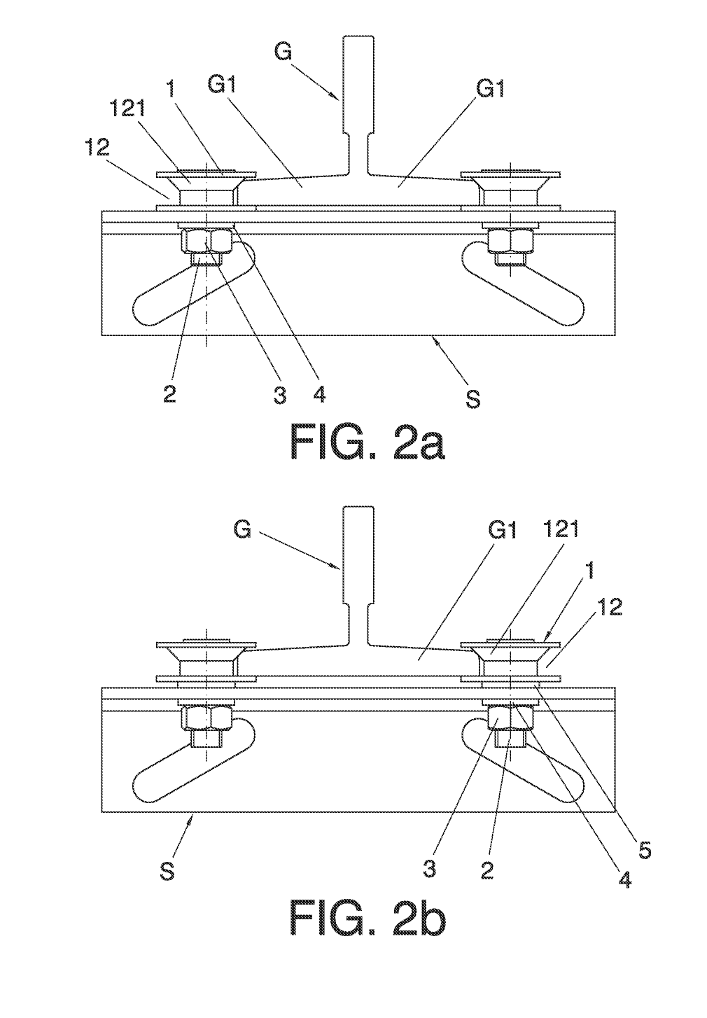

FIG. 2a represents a general schematic plan view, corresponding to FIG. 1 for a solution in which the rotary element (1) remains static,

FIG. 2b represents a general schematic plan view, corresponding to FIG. 1 for a solution in which the rotary element (1) can turn.

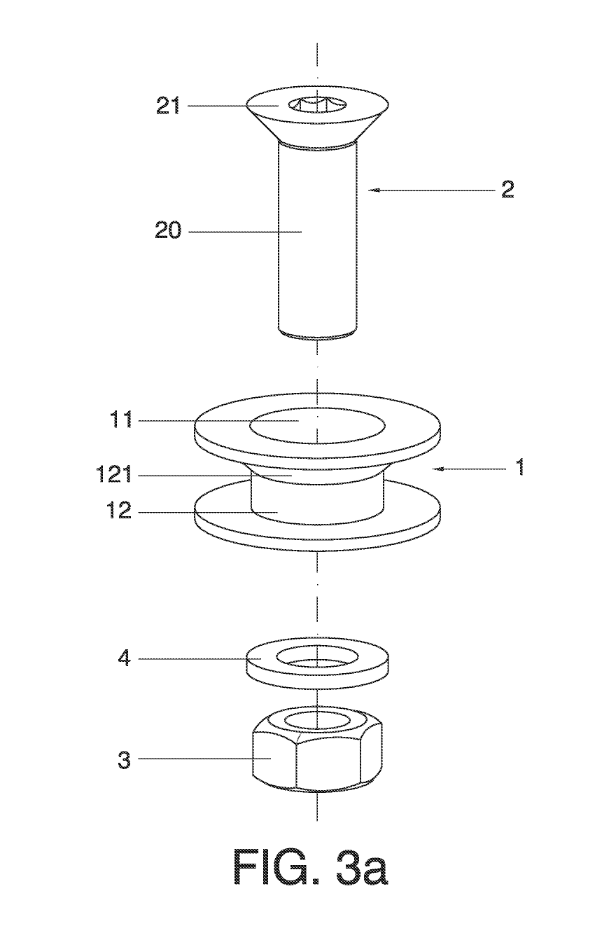

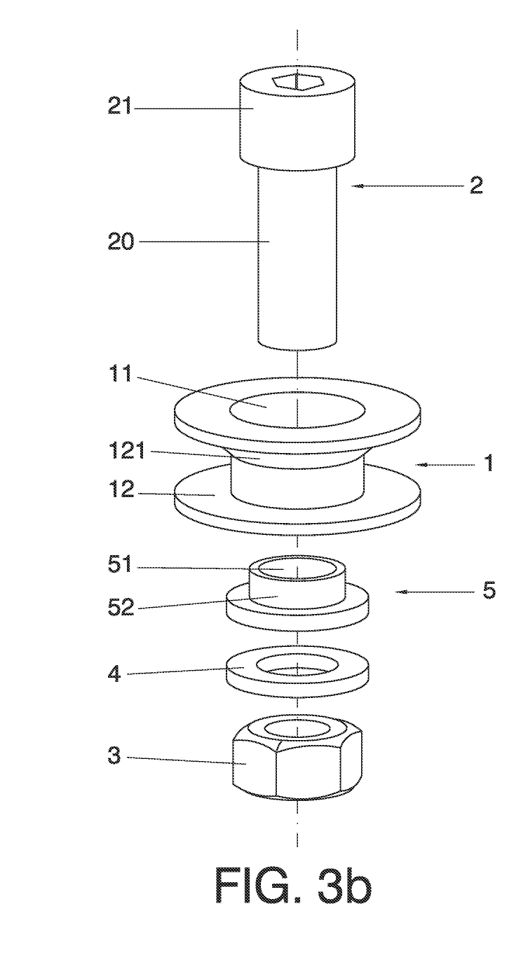

FIG. 3a represents a general schematic breakdown of one of the semi-parts of the adjustment flange that is the object of the invention, with its components in assembly arrangement for the embodiment of FIG. 2a.

FIG. 3b represents a general schematic breakdown of one of the semi-parts of the adjustment flange that is the object of the invention, with its components in assembly arrangement for the embodiment of FIG. 2b.

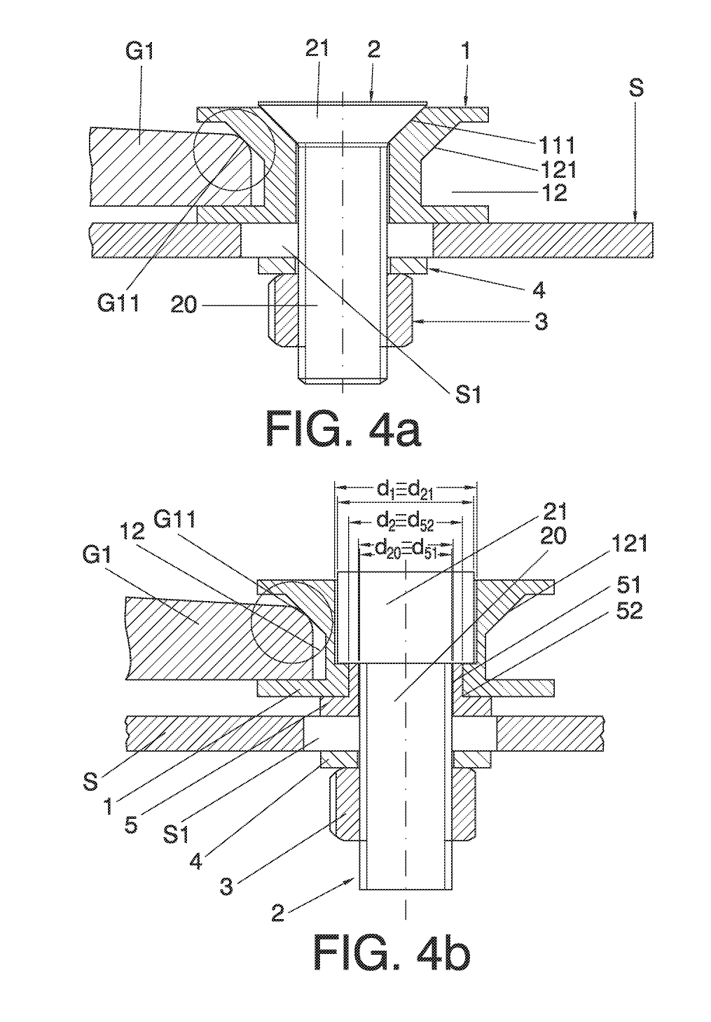

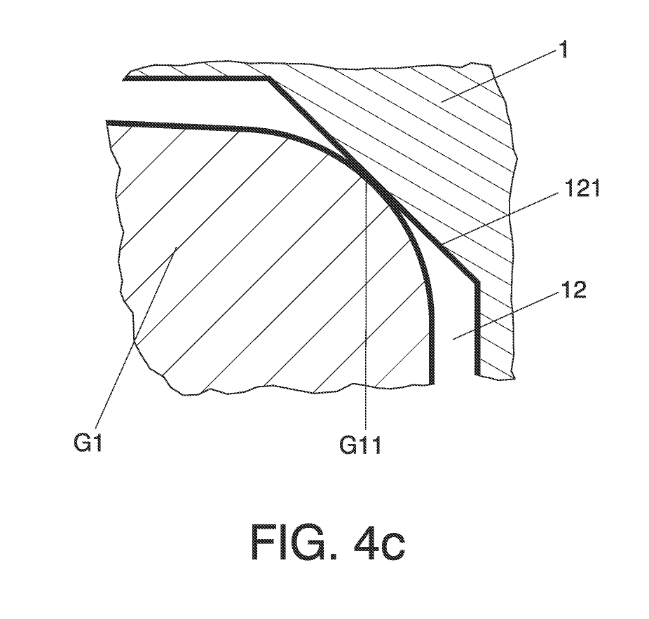

FIG. 4a represents a general schematic section of one of the semi-parts of the adjustment flange that is the object of the invention, with its components assembled for the embodiment of FIG. 2a, 3a.

FIG. 4b represents a general schematic section of one of the semi-parts of the adjustment flange that is the object of the invention, with its components assembled for the embodiment of FIG. 2b, 3b.

FIG. 4c represents the enlarged breakdown indicated in FIGS. 4a and 4b.

The following is a description of an example of practical, non-limiting embodiment of this invention. Other modes of embodiment in which accessory changes are introduced that do not essentially alter its basis are in no way discarded; on the contrary, this invention also includes all its variations.

According to the invention, the adjustment flange that is the object of the invention is structured in two identical semi-parts fastened on a support (S) clamping the lift guide between them (G)—See FIG. 1—.

The lift guide (G) is of the type that has two wings (G1) with a chamfer or common radius (G11) on each of them.

The support (S) is of the type that has orifices/housing (Si) both to fasten the flange and to be fastened to the wall or to a fixed structure.

Each of said semi-parts of the adjustment flange, according to the invention and for an embodiment in which the rotary element (1) remains static, consists of a rotary element (1), an anchor bolt (2), a nut (3); a washer (4), and a bushing (5).

For an embodiment in which the rotary element (1) can turn, a bushing (5) is also placed, as described later.

For any of the embodiments:
the rotary element (1) is equipped with an axial orifice (11) and a perimeter channel (12);
the perimeter channel (12) is of asymmetric section, with a chamfer or perimeter internal common radius (121), and
the body (20) of the anchor bolt (2) passes through said axial orifice (11) and one of the orifice/housing (S1) of the support (S) positioned facing it.

Description of the embodiment represented in the FIGS. 2a, 3a, 48, in which the rotary element (1) cannot turn.

The orifice (11) defines a countersink hole (111) in relation to one of the faces of the rotary element (1).

The head (21) of the anchor bolt (2) is countersunk in conjugation to be housed in the countersink hole (111) of the orifice (11) and may or may not protrude with respect to the relevant face of the rotary element (1).

The nut (3) is threaded in the body (20) of said bolt (2) with interposition of a washer (4), and it fastens the rotary element (1) compressing it between the support (S) and the head itself(21) of the bolt (2).

With this structure, components and basic configuration, and with the flange mounted:
the lift guide (G) is fitted between the two rotary elements (1) positioned facing each other, and with their wings (G1) housed in their perimeter channels (12) so that the chamfer or internal common radius (121) is dimensionally and positionally conjugated from the chamfer or common radius (G11) provided on the wing ((31) of the lift guide (G) it adjusts;
the head (21) of the bolt (2) is housed in the countersink hole (111) of said axial orifice (11) of the rotary element (1), and may or may not protrude with respect to the relevant face of the rotary element (1).

Description of the embodiment represented in FIGS. 2b, 3b, 4b, on which the rotary element (1) can turn.

The axial orifice (11) defines two successive zones (11a), (11b) of different diameters (d₁), (d₂), that contact each other in perpendicular grading.

The bolt (2) defines a body (20) and a head (21) of different diameters (d₂₀), (d₂₁), that contact each other in perpendicular grading.

The bushing (5) has an axial orifice (51) of inner diameter (d₅₁) and a perimeter seat (52) of outer diameter (d₅₂).

The diameters (d₁) of the axial orifice (11) of the rotary element (1) y (d₂₁) of the head (21) of the bolt (2) are interconjugated.

The diameters (d₂) of the axial orifice (11) of the rotary element (1) y (d₅₂) of the seat (52) of the bushing (5) are interconjugated.

The diameters (d₂₀) of the body (20) of the bolt (2) y (d₅₁) of the axial orifice of the bushing (5) are interconjugated.

In the assembly of the adjustment flange, according to this embodiment, the grading of the axial orifice (11) of the rotary element (1) between its two successive zones (11a),(11b) and the grading of the bolt (2) between its body (20) and its head (21) there remains a minimal clearance that allows the rotation of the flange.

With this structure, components and basic configuration, and with the adjustment flange assembled:
the lift guide (G) is fitted between the two rotary elements (1) positioned facing each other, and with their wings (G1) housed in their perimeter channels (12) so that the chamfer or internal common radius (121) is dimensionally and positionally conjugated from the chamfer or common radius (G11) provided on the wing (G1) of the lift guide (G) it adjusts;
the head (21) of the bolt (2) is housed in the zone (11a) of said axial orifice (11) of the rotary element (1), and may or may not protrude with respect to the relevant face of the rotary element (1).
the body (20) of the anchor bolt (2) also passes through one of the orifices/housing (S1) of the support (S) positioned facing it.
the nut (3) is threaded at the end of the body (20) of said bolt (2) with interposition of a washer (4), so that said bolt (2), by the action of the nut (3), fastens the bushing axially (5) compressing it between the support (5) and its own head (21), while positioning the rotary element (1) without axial movement so that it can turn freely in the seat (52) of the bushing (5).

The materials, dimensions, proportions and, in general, those other accessory or secondary details that do not alter, change or modify the essential proposal may be variable.

The terms in which this report is written are a true reflection of the object described, and must be taken in their broadest sense and never in a limiting manner.

1. An adjustment flange for lift guides, comprising: two identical semi-parts fastened on a support clamping the lift guide between them, each of said semi-parts comprising:
a) a rotary element provided with an axial orifice and a perimeter channel of asymmetric section;
b) an anchor bolt, that passes through said axial orifice and an orifice/housing of the support positioned facing it; and
d) a nut, threaded in the body of said bolt with interposition of a washer; being fitted to the lift guide between the two rotary elements positioned facing each other, and with their wings housed in their perimeter channels.

2. An adjustment flange for lift guides, according to claim 1, wherein:
a) the axial orifice of the rotary element defines two successive zones, of different diameters that contact each other according to perpendicular grading of both generatrices,
b) the anchor bolt defines body and head of different diameters that contact each other according to perpendicular grading of both generatrices,
c) there is a bushing provided with an axial orifice and a perimeter seat;
so that said bolt, by the action of the nut, fastens the bushing axially, compressing it between the support and its own head, while positioning the rotary element without axial movement so that it can turn freely in the seat of the bushing.

3. An adjustment flange for lift guides; according to claim 1, wherein said perimeter channel of the rotary element defines a chamfer or internal common radius dimensionally and positionally conjugated from the chamfer or common radius provided on the wing of the lift guide it adjusts.

4. An adjustment flange, for lift guides; according to claim 1, wherein said axial orifice of the rotary element defines a countersink hole which houses the head of the bolt dimensionally and posicionally conjugated, and may or may not protrude with respect to the flat face of the rotary element.

5. An adjustment flange for lift guides, according to claim 2, wherein the diameters of the axial orifice of the rotary element and of the head of the bolt are interconjugated; the diameters of the axial orifice of the rotary element and of the seat of the bushing are interconjugated; and the diameters of the body of the bolt y of the axial orifice of the bushing are interconjugated.
